(19) United States
(12) Patent Application Publication
(10) Pub. No.: US 2005/0094658 A1
(43) Pub. Date: May 5, 2005

(54) Method and apparatus for multicast packet transmission

(76) Inventors: Jen-Kai Chen, Sindian City (TW); Chia-Hsin Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/960,085

(22) Filed: Oct. 8, 2004

(30) Foreign Application Priority Data
Oct. 8, 2003 (TW) 092128016

(51) Int. Cl. H04L 12/56

(52) U.S. Cl. 370/432

(57) ABSTRACT

A method for transmitting multi-cast packets is provided, including the steps of (a) receiving a plurality of multi-cast packets and generating corresponding port masks to indicate a plurality of ports from which the multi-cast packets are to be transmitted, (b) selecting, based on the yet-enqueued ports indicated in port masks, a port with highest priority, enqueuing the multi-cast packet into the port, and updating the port masks, (c) checking whether the port with highest priority being full-duplex, and (d) determining when to repeat steps (b) to (d) base on the result of the checking, until finishing the transmission specified by the port masks. In step (d), when the port with highest priority is full-duplex, wait until the port with highest priority starting transmitting the packet, then repeat steps (b) to (d). On the other hand, when the port with highest priority is half-duplex, wait until the port with highest priority transmitting a certain portion of the packet, for example 64 bytes or 128 bytes, then repeat steps (b) to (d). This will repeat until finishing all the transmission specified by the port masks. Preferably, the port with highest priority means the port of the highest priority group with the shortest output queue. When finishing all the transmission specified by the port masks, the switch will release all the related buffers of the multi-cast packets.

### BACKGROUND OF THE INVENTION

1. Field of the Invention

The present invention generally relates to a method and an apparatus for Ethernet packet transmission and, more particularly, to a method and a switching apparatus for forwarding multicast packets.

2. The Related Art

An Ethernet switch provides the multi-port connection for computer networks, with each port able to support a 10 M/100 M/1000 M full-duplex transmission. The Ethernet switch has a buffered memory for buffering the packets, and allocates several “buffers” for temporarily storing the incoming Ethernet packets, wherein “buffer” is the allocation unit for the buffered memory and each buffer occupies a fixed space therein. In general, the length of an Ethernet packet does not exceed 1522 bytes, and the unit buffer in a switch is defined as 128 bytes (or 256 bytes). When a 256-byte packet enters the switch, the packet requires occupying two buffers in the buffered memory. A 260-byte packet then requires occupying three buffers.

In general, the packets received by Ethernet switches are categorized as unit-cast, multi-cast, and broadcast packets. Unit-cast packets are received from one port of the switch and transmitted from another port. Multi-cast packets are received from one port of the switch and transmitted from a plurality of other ports, while broadcast packets are received from one port of the switch and transmitted from all the remaining ports. Therefore, all the broadcast packets can be considered as a special case of multi-cast packets.

FIG. 1 shows a schematic view of an Ethernet switch, designated with reference numeral 100, for broadcasting a packet from port 1 with all queues empty. Ethernet switch 100 has eight ports, port 0 to port 7, where the line speed of ports 0, 5, 6, and 7 is 1000 Mbps (bits per second), the line speed of ports 1 and 4 is 100 Mbps, and the line speed of ports 2 and 3 is 10 Mbps. Prior arts typically transmit the packets on the ports with higher line speed at first, and smaller port number with the same line speed has higher transmission priority.

The first test procedure, as shown in FIG. 1, is performed when the output queues of all the ports are empty. The following discussion uses the time for a 1000 M port to transmit a buffer-sized data as the unit for t. When t=0, a 256-byte broadcast packet is received from port 0 for broadcasting from port 1 to port 7. For precise explanation, the 256-byte broadcast packet arrives at time t=0− and enters the Ethernet switch 100 at time t=0, wherein t=0− represents the time is just before t=0. A 256-byte broadcast packet must occupy two buffers, and takes two time units when transmitting directly from a 1000 M port. Therefore, the 256-byte broadcast packet enters port 0 (t=0), it is first transmitted from port 5, and finishes the transmission at t=2. The packet is then placed in the output queue of port 6, starting transmission at t=2+, and finishing transmission at t=4, wherein t=2+ represents the time is right after t=2. The packet is then again placed in the output queue of port 7, starting transmission at t=4+, and finishing transmission at t=6. At this point, all 1000 M ports have finished transmitting the packet. The packet is then placed into the output queue of port 1, starting transmission at t=6+, and finishing transmission at t=26, because port 1 has the line speed of 100 M and takes 20 time units to transfer two buffers. The packet is then placed in the output queue of port 4, starting transmission at t=26+, and finishing transmission at t=46. At this point, all 100 M ports have finished transmitting the packet. The packet is then placed into the output queue of port 2, starting transmission at t=46+, and finishing transmission at t=246, because port 2 has the line speed of 10 M and takes 200 time units to transfer two buffers. The packet is then placed in the output queue of port 3, starting transmission at t=246+, and finishing transmission at t=446. As shown in FIG. 1, the starting transmission times of port 0 to port 7 are [6, 46, 246, 26, 0, 2, 4], respectively.

The second test method, as shown in FIG. 2 of the attached drawings, is performed when the output queues of the ports are not all empty. At t=0, the lengths of the output queues of port 1 to port 7 are 4, 3, 0, 1, 2, 0, 1, respectively. When a 256-byte broadcast packet enters port 0 at t=0, it is to be transmitted from ports in the order of 5, 6, 7, 1, 4, 2, 3. At t=0, port 5 has two buffers for transmission. Therefore, the broadcast packet is not transmitted until t=2, and finishes the transmission at t=4. It is placed into the output queue of port 6, starting transmission at t=4+, and finishing transmission at t=6. It is then placed in the output of port 7 for transmission, and so on. The broadcast packet must wait until the port empties its output queue to start transmitting the broadcast packet, hence the delay in the starting time. In this example, the starting transmission times of the ports are [40, 300, 500, 60, 2, 4, 6], respectively.

Broadcast packets are considered as a special case of multi-cast packets. The most efficient way of broadcasting is to enqueue the packet simultaneously into the output queues of all the output ports when the packet is received from port 0. This method also requires a plurality of counters to count the number of ports that each broadcast or multi-cast packet has finished transmitting to avoid the releasing of buffer before the packet finishes all the transmission. Using the above method, the starting transmission times in FIG. 2 will be [40, 300, 0, 10, 2, 0, 1], respectively. However, this method takes a lot of buffer space and counters of output queues. Therefore, it is not an optimal solution for hardware design.

### SUMMARY OF THE INVENTION

The present invention discloses a method for transmitting multi-cast packets, comprising the steps of (a) receiving a plurality of multi-cast packets and generating corresponding port masks to indicate a plurality of ports from which the multi-cast packets are to be transmitted, (b) selecting, based on the yet-enqueued ports indicated in port masks, a port with highest priority, enqueuing the multi-cast packet into the port, and updating the port masks, (c) checking whether the port with highest priority being full-duplex, and (d) determining when to repeat steps (b) to (d) base on the result of the checking, until finishing the transmission specified by the port masks. In step (d), when the port with highest priority is full-duplex, wait until the port with highest priority starting transmitting the packet, then repeat step (b) to (d). On the other hand, when the port with highest priority is half-duplex, wait until the port with highest priority transmitting a certain portion of the packet, for example 64 bytes or 128 bytes, then repeat steps (b) to (d). This will repeat until finishing all the transmission specified by the port masks. Preferably, the port with highest priority means the port of the highest priority group with the shortest output queue. When finishing all the transmission specified by the port masks, the switch will release all the related buffers of the multi-cast packets.

The present invention further discloses a media access control chip for coupling physical layer control chip. The media access control chip comprises a plurality of port control units, a forwarding control unit, a queue control unit, a shortest queue identification unit and a buffer control unit. The forwarding control unit couples the port control units and the queue control unit. The queue control unit couples forwarding control unit and port control units. The shortest queue identification unit couples queue control unit. The buffer control unit couples buffer storage and port control unit. When a port control unit receives a multi-cast packet, the transmission control unit generates a corresponding port mask for the packet by looking up a table. The buffer control unit allocates buffers from the buffer storage area to store the multi-cast packet. The queue control unit and the shortest queue identification unit coordinate to identify and enqueue the multi-cast packet into the output queue of the port of the highest priority group and with the shortest queue. If the port with the shortest queue of the highest priority is full-duplex, the multi-cast packet is enqueued to the next associated port once the transmission starts. If the port with the shortest queue of the highest priority is half-duplex, the multi-cast packet is enqueued to the next associated port only when a certain portion of the packet has been transmitted.

The present invention further discloses an Ethernet switch having a plurality of ports, comprising a physical layer control chip for a plurality of ports, and a media access control chip coupling the physical layer control chip. The physical layer control chip is for receiving multi-cast packet, and the media access control unit generates a corresponding port mask for the multi-cast packet, and enqueues the multi-cast packet to the queue of the port of the highest priority group and with the shortest queue in accordance with the port mask.

The present invention also discloses a multi-cast packet transmission method, comprising the steps of: (a) recording the capability of a plurality of remote ports based on the automatic coordination result of the Ethernet, (b) determining the priority of a plurality of local ports in accordance with the transmission capability, (c) receiving the multi-cast packet and generating corresponding port mask to indicate a plurality of local ports that the packet is to transmitted from, (d) selecting the port with the highest priority and enqueuing the multi-cast packet into the queue associated with the port and updating the port mask, (e) checking if the port with the highest priority is full-duplex, and (f) repeating steps (d) to (f) based on the result of step (e) and repeating until finishing all the transmission specified by the port mask.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention will be apparent to those skilled in the art by reading the following description of preferred embodiments thereof, with reference to the attached drawings, in which:

FIG. 1 is a schematic view of an Ethernet switch performing the empty queue test method for the broadcast packet;

FIG. 2 is a schematic view of an Ethernet switch performing the non-empty queue test method for the broadcast packet;

FIG. 3 is a flow chart of a multi-cast packet transmission method with early enqueuing according to an embodiment of the present invention;

FIG. 4 is a flow chart of a multi-cast packet transmission method with early enqueuing according to another embodiment of the present invention; and

FIG. 5 is a hardware block diagram according to an embodiment of the present invention.

### DETAILED DESCRIPTION OF THE PREFERRED EMBODIMENTS

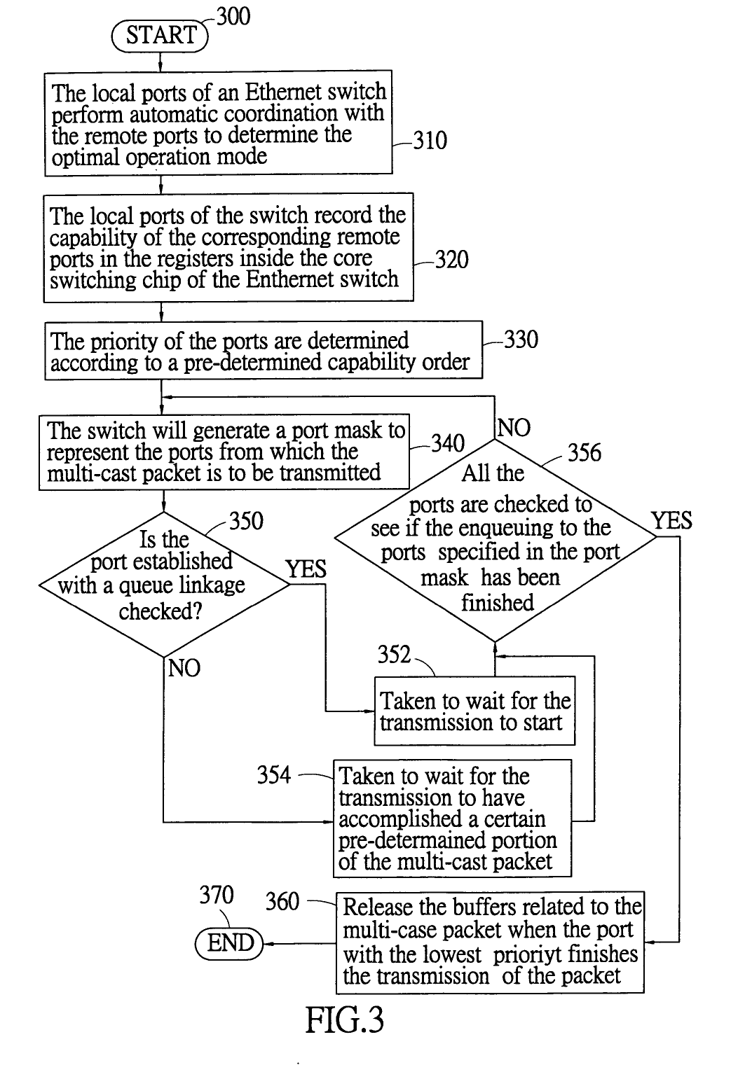

With reference to the drawings and in particular to FIG. 3, which shows a flow chart of a multi-cast packet transmission method with early enqueuing in accordance with the present invention, in step 310, the local ports of an Ethernet switch perform automatic coordination with the remote ports to determine the optimal operation mode. In step 320, the local ports of the switch record the capability of the corresponding remote ports in the registers inside the core switching chip of the Enthernet switch. In step 330, the priority of the ports are determined according to a pre-determined capability order, preferably, the pre-determined capability order is as follows: (1) 1000 M/full-duplex, (2) 100 M/half-duplex, (3) 100 M/full-duplex, (4) 100 M/half-duplex, (5) 10 M/full-duplex, and (6) 10 M/half-duplex. As an Ethernet switch has a plurality of ports, it is possible that several ports have the same capability, and thus of the same priority group. In this case, the higher priority is given to the port with a smaller port number. In step 340, when the Ethernet switch receives a multi-cast packet, the switch will generate a port mask to represent the ports from which the multi-cast packet is to be transmitted, and establishes, based on the port mask, a queue linkage to the port with the highest priority and a port linkage is yet established. The establishment of a queue linkage is also called enqueuing for the rest of the description. In step 350, the port established with a queue linkage is checked. If it is full-duplex, step 352 is taken to wait for the transmission to start, and then proceed to step 356. Otherwise, if the port is half-duplex, step 354 is taken to wait for the transmission to have accomplished a certain pre-determined portion of the multi-cast packet, and proceed to step 356. In step 356, all the ports are checked to see if the enqueuing to the ports specified in the port mask has been finished. If not, take step 340 to enqueue all the ports specified in the port mask. When the enqueuing operation is finished, take step 360 to release the buffers related to the multi-case packet when the port with the lowest priority finishes the transmission of the packet. Finally, take step 370 to end the transmission process.

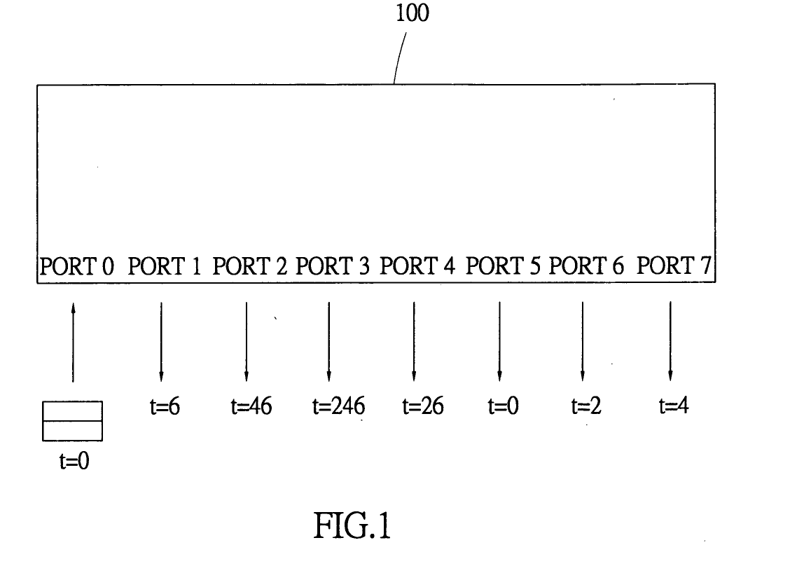

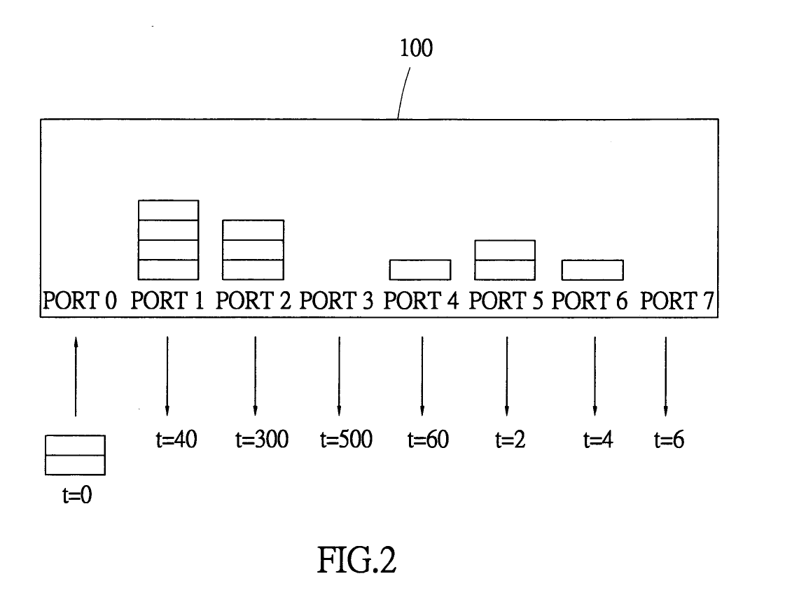

An Ethernet switch with eight ports, as that illustrated in FIGS. 1 and 2, is taken as an example for illustration purposes. First, the ports of the switch coordinate with the remote ports to determine the optimal operation mode and record the capability of the corresponding remote ports in the registers inside the core switching chip of the Enthernet switch, including transmission speed and full-duplex/half-duplex. The priority of the ports is determined according to a pre-determined capability order as follows: (1) 1000 M/full-duplex, (2) 1000 M/half-duplex, (3) 100 M/full-duplex, (4) 100 M/half-duplex, (5) 10 M/full-duplex, and (6) 10 M/half-duplex. The higher priority is given to the port with a smaller port number of the same priority group. In this embodiment, the priority order given to port 1 to port 7 is [4, 6, 7, 5, 1, 2, 3].

To avoid the race condition between the buffer release and the transmission of the multi-cast packet, the packet can be enqueued into the next port as soon as the transmission of the current port starts when the current port is full-duplex. On the other hand, if the current port is half-duplex, the enqueuing must wait until the half-duplex port passes the worse-case late collision boundary. This is to avoid the collision during the transmission so that the resending of the packet by the half-duplex port is later than the transmission time of the next port and a race condition occurs. In this embodiment, the worse-case late collision boundary is set to be 64 bytes to meet the specification of Ethernet. But in hardware design, it is suggested to have a longer worse-case late collision boundary, such as 128 bytes, for better safety.

Considering the test method in FIG. 1 for the empty queues in all ports. At t=0, the 256-byte broadcast packet is received by port 0, and the early enqueuing is performed in the order of port 5, port 6, port 7, port 1, port 4, port 2, and port 3. As all the output queues are empty and all the ports are full-duplex, the early enqueuing can be performed directly without the concern of collision boundary. The transmission times of port 1 to port 7 are [0, 0, 0, 0, 0, 0, 0].

Considering the test method in FIG. 2 for non-empty queues in some ports. At t=0, the lengths of the output queue in each port are [4, 3, 0, 1, 2, 0, 1]. At t=0, a 256-byte broadcast packet is received by port 0, and the transmission priority determined by the transmission speed is in the order of port 5, port 6, port 7, port 1, port 4, port 2, and port 3. As there are two packets in the output queue of port 5, at transmission speed of 1000 Mbps, port 5 starts transmitting the broadcast packet at t=2+. Port 6 also starts transmission simultaneously at t=2+. As for port 7, because the original packet in the output queue of port 7 will have finished transmission by t=2, port 7 can also start transmission the broadcast packet at t=2+. Because port 1 has the speed of 100 Mbps, it can only start transmission at t=40+. For port 4, because the original packet in the output queue of port 4 will have finished transmission by t=40, port 4 can also start transmission the broadcast packet at t=40+. Port 2 has the transmission speed of 10 Mbps, the transmission of the broadcast packet will be delayed by the original three packets in the output queue until t=300. Therefore, port 2 and port 3 will only start transmitting at t=300+. Therefore, the starting times for transmission for port 1 to port 7 are [40, 300, 300, 40, 2, 2, 2].

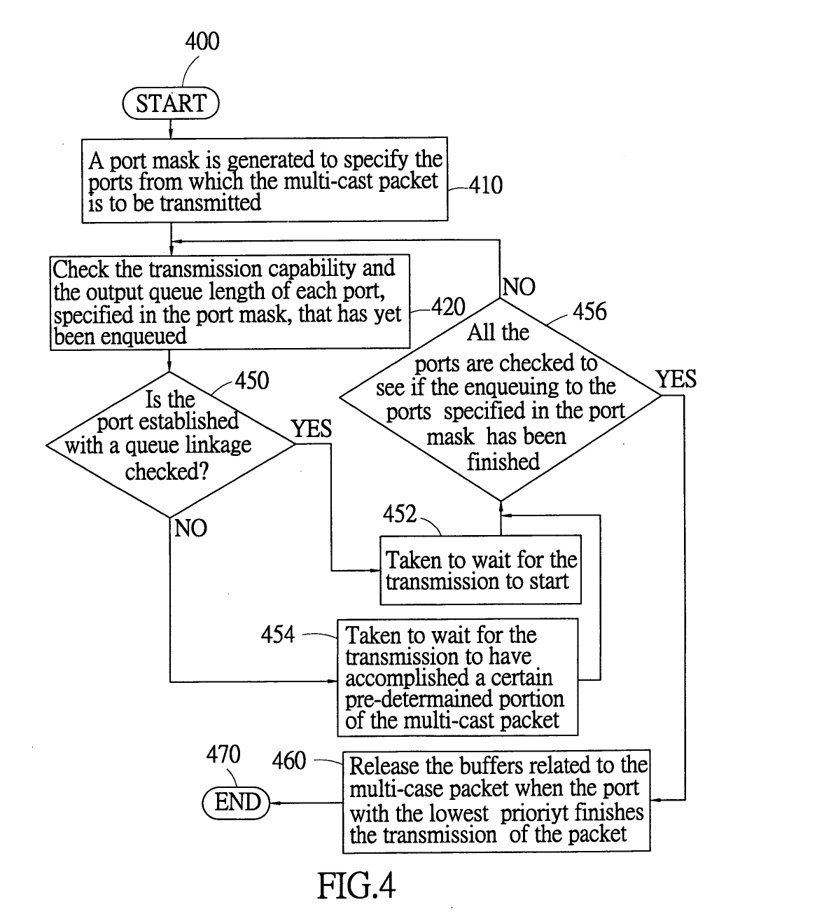

In the second embodiment of the present invention, the output queue length is taken into account to obtain a better performance. Use the previous six priority categories and the test method in FIG. 2 as example. The output queue lengths of port 1 to port 7 at t=0 are [4, 3, 0, 1, 2, 0, 1], respectively. As shown in FIG. 4, a multi-cast packet is received by a port in an Ethernet switch. A port mask is generated to specify the ports from which the multi-cast packet is to be transmitted. In step 420, check the transmission capability and the output queue length of each port, specified in the port mask, that has yet been enqueued. Preferably, the capability priority is in the order of (1) 1000 M/full-duplex, (2) 1000 Mhalf-duplex, (3) 100 M/full-duplex, (4) 100 M/half-duplex, (5) 10 M/full-duplex, and (6) 10 M/half-duplex. In each priority group, a higher priority is given to the port with a smaller output queue length. In step 450, the enqueued port is checked. If it is full-duplex, step 452 is taken to wait for the transmission to start, and then proceed to step 456. Otherwise, if the port is half-duplex, step 454 is taken to wait for the transmission to have accomplished a certain pre-determined portion of the multi-cast packet, and proceed to step 456. In step 456, all the ports are checked to see if the enqueuing to the ports specified in the port mask has been finished. If not, take step 420 to enqueue all the ports specified in the port mask. When the enqueuing operation is finished, take step 460 to release the buffers related to the multi-case packet when the port with the lowest priority finishes the transmission of the packet. Finally, take step 470 to end the transmission process.

Considering the test method in FIG. 2 for non-empty queues in some ports, and taking the transmission capability and output queue length of each port into account. At t=0, the lengths of the output queue in each port are [4, 3, 0, 1, 2, 0, 1]. At t=0, a 256-byte broadcast packet is received by port 0. Port 5, port 6, and port 7 all have the transmission speed of 1000 Mbps/full-duplex, port 1 and port 4 have the transmission speed of 100 Mbps/full-duplex, and port 2 and port 3 have the transmission speed of 10 Mbps/full-duplex. Although port 5, port 6, and port 7 all have the same transmission speed, the output queue length of each port is different from one another. Therefore, the transmission priority determined by the output queue length is in the order of port 6, port 7, and port 5. At t=0, the shortest output queue is at port 6 (length=0), the packet is enqueued into the output queue of port 6, and port 6 starts the transmission at t=0+, and the enqueuing to port 7 starts simultaneously at t=0+. Port 7 finishes transmitting the original packet in the output queue and starts transmitting the multi-cast packet at t=1+, and enqueues the packet to port 5, which finishes transmitting the original two packets at t=2, and starts transmitting the multi-cats packet at t=2+, and enqueues the packet to port 4. This is because port 4 has a shorter output queue than port 1, and both have the same transmission capability, 100 Mbps/full-duplex. Therefore, port 4 is given a higher priority than port 1. With the transmission speed of 100 Mbps, port 4 finishes transmitting the original packet at t=10, starts transmitting the multi-cast packet at t=10+, and enqueues the packet to port 1 simultaneously. Port 1 finishes transmitting the original four packets at t=40, starts transmitting the multi-cast packet at t=40+, and enqueues the packet to port 3 simultaneously. Again, this is because port 3 has a shorter output queue than port 2, and both have the same transmission capability, 10 Mbps/full-duplex. Therefore, port 3 is given a higher priority than port 2. As port 3 has an empty output queue, it starts transmitting the multi-cast packet at t=40+, and enqueues the packet to port 2 simultaneously. Port 2 finishes transmitting the original three packets in the output queue at t=300, and starts transmitting the multi-cast packet at t=300+. Therefore, the starting times of transmission of port 1 to port 7 are [40, 300, 40, 10, 2, 0, 1], respectively. The time at which the packet is enqueued at each port and the time starting transmitting are greatly improved in the new method. Furthermore, the hardware design is simplified, and the buffer allocation constrain is less demanding.

In the second embodiment, if port 1 and its corresponding remote port are operating in a 100 Mbps/half-duplex mode, port 1 will start transmitting at 40+, but port 3 preferably must wait for the enqueuing until port 1 finishing transmitting 128 bytes of the multi-cast packet in addition to its original four packets, as shown in FIG. 2. That is, the packet is enqueued in port 3 at t=50+. In this case, the enqueuing time at port 2 is delayed, but the starting transmitting time is not. The starting time of transmission for port 1 to port 7 is [40, 300, 50, 10, 2, 0, 1], respectively.

In the same priority group, the determination of output queue length can be achieved by a simple hardware design. For example, a queue length represented by 12 bits QL[11:0] can be easily represented by 3-bit weight, w[2:0]. Set w[0]=QL[0], w[1]=(or QL[4:1]), w[2]=(or QL[11:5]), where the “or” indicates the Boolean operation “or”. Therefore, w[1]=1 indicates that the middle-ranged bits [4:1] of the queue length is non-zero. The rough queue length can be determined by using fewer bits.

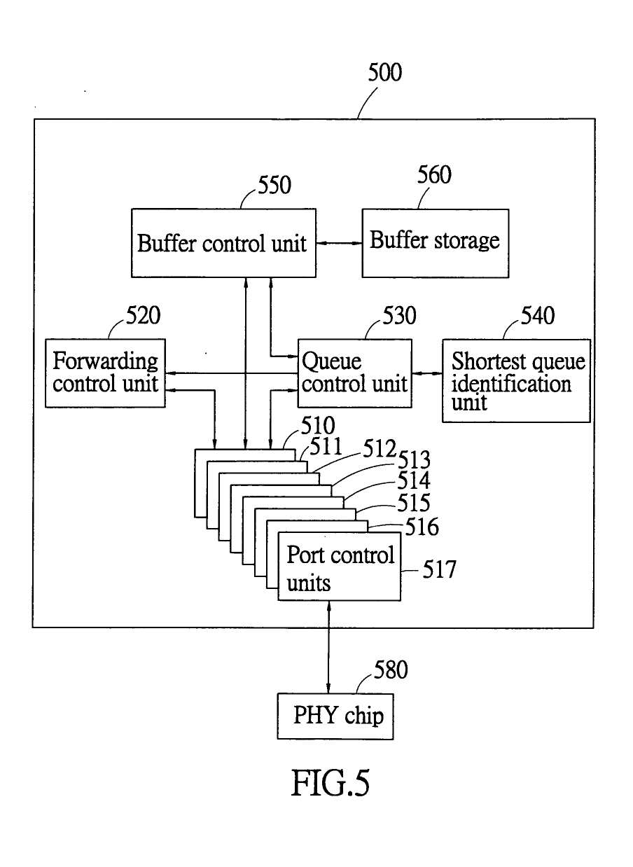

FIG. 5 shows a hardware embodiment of previous flowchart. An Ethernet switch comprises a media access control (MAC) chip 500, and a physical layer control (PHY) chip 580. Preferably, MAC chip 500 uses a reduced medium independent interface (RMII) to couple PHY chip 580. MAC chip 500 further comprises port control units 510-517 (corresponding to port 0 to port 7 in the previous 8-port switch example), a forwarding control unit 520, a queue control unit 530, a shortest queue identification unit 540, a buffer control unit 550, and a buffer storage 560. Port control unit 510 couples forwarding control unit 520, queue control unit 530 and buffer control unit 550. Buffer control unit 550 couples buffer storage 560. PHY chip 580 is responsible for the transmission and receiving of external physical electrical signal of the switch. The processing method disclosed above is related to the internal operation of MAC chip 500. The packet received by port 0 of the Ethernet switch, through PHY chip 580, reaches port control unit 510, and forwarding control unit 520 generates a corresponding port mask. For example, by look-up table, a port mask can be generated. Buffer control unit 550 allocates an appropriate number of buffers from buffer storage 560 to provide temporary storage for the packet. Queue control unit 530 enqueues the packet according to the port mask. Queue control unit 530 determines, based on the output queue length of each port, how fast each port consumes buffer storage 560, and signals port control unit 510 to perform an appropriate congestion control. Preferably, the shortest queue identification unit 540 couples queue control unit 530 to determine the port with the shortest output queue within the same priority group, and signals queue control unit 530 to enqueue the packet to the identified port.

The embodiment of FIG. 5 can be adjusted in accordance with different manufacturing process. For example, buffer storage 560 can be integrated with MAC chip 500, or as a stand-alone chip. Depending on the access speed, buffer storage 560 can be SRAM, SDRAM, or DDR. PHY chip 580, due to the specific manufacturing process to provide physical layer control to many ports, is usually a stand-alone chip. But as the integration improves in the future, it is possible to integrate PHY chip 580 into MAC chip 500.

In summary, the present invention discloses a method for transmitting multi-cast packets, comprising the steps of (a) receiving a plurality of multi-cast packets and generating corresponding port masks to indicate a plurality of ports from which the multi-cast packets are to be transmitted, (b) selecting, based on the yet-enqueued ports indicated in port masks, a port with highest priority, enqueuing the multi-cast packet into the port, and updating the port masks, (c) checking whether the port with highest priority being full-duplex, and (d) determining when to repeat steps (b) to (d) base on the result of the checking, until finishing the transmission specified by the port masks. In step (d), when the port with highest priority is full-duplex, wait until the port with highest priority starting transmitting the packet, then repeat steps (b) to (d). On the other hand, when the port with highest priority is half-duplex, wait until the port with highest priority transmitting a certain portion of the packet, for example 64 bytes or 128 bytes, then repeat steps (b) to (d). This will repeat until finishing all the transmission specified by the port masks. Preferably, the port with highest priority means the port of the highest priority group with the shortest output queue. When finishing all the transmission specified by the port masks, the switch will release all the related buffers of the multi-cast packets.

The present invention further discloses a media access control chip for coupling physical layer control chip. The media access control chip comprises a plurality of port control units, a forwarding control unit, a queue control unit, a shortest queue identification unit and a buffer control unit. The forwarding control unit couples the port control units and the queue control unit. The queue control unit couples forwarding control unit and port control units. The shortest queue identification unit couples queue control unit. The buffer control unit couples buffer storage and port control unit. When a port control unit receives a multi-cast packet, the transmission control unit generates a corresponding port mask for the packet by looking up a table. The buffer control unit allocates buffers from the buffer storage area to store the multi-cast packet. The queue control unit and the shortest queue identification unit coordinate to identify and enqueue the multi-cast packet into the output queue of the port of the highest priority group and with the shortest queue. If the port with the shortest queue of the highest priority is full-duplex, the multi-cast packet is enqueued to the next associated port once the transmission starts. If the port with the shortest queue of the highest priority is half-duplex, the multi-cast packet is enqueued to the next associated port only when a certain portion of the packet has been transmitted.

The present invention further discloses an Ethernet switch having a plurality of ports, comprising a physical layer control chip for a plurality of ports, and a media access control chip coupling the physical layer control chip. The physical layer control chip is for receiving multi-cast packet, and the media access control unit generates a corresponding port mask for the multi-cast packet, and enqueues the multi-cast packet to the queue of the port of the highest priority group and with the shortest queue in accordance with the port mask.

The present invention also discloses a multi-cast packet transmission method, comprising the steps of: (a) recording the capability of a plurality of remote ports based on the automatic coordination result of the Ethernet, (b) determining the priority of a plurality of local ports in accordance with the transmission capability, (c) receiving the multi-cast packet and generating corresponding port mask to indicate a plurality of local ports that the packet is to transmitted from, (d) selecting the port with the highest priority and enqueuing the multi-cast packet into the queue associated with the port and updating the port mask, (e) checking if the port with the highest priority is full-duplex, and (f) repeating steps (d) to (f) based on the result of step (e) and repeating until finishing all the transmission specified by the port mask.

Although the present invention has been described with reference to the preferred embodiments thereof, it is apparent to those skilled in the art that a variety of modifications and changes may be made without departing from the scope of the present invention which is intended to be defined by the appended claims.

1. A method for transmitting multi-cast packets, comprising the steps of:
(a) receiving a multi-cast packet and generating a corresponding port mask to specify a plurality of ports from which said multi-cast packet is to be transmitted;
(b) selecting, based on the yet-enqueued ports specified in said port mask, a port with the highest priority, enqueuing said multi-cast packet into said port, and updating said port mask;
(c) checking whether said port with the highest priority being full-duplex; and
(d) determining when to repeat steps (b) to (d) based on the result of said checking, till finishing the transmission specified by said port mask.

2. The method as claimed in claim 1, wherein said step (d) is to wait until said port with the highest priority starting transmitting said packet, then repeat said steps (b) to (d), when said port with the highest priority is full-duplex.

3. The method as claimed in claim 1, wherein said step (d) is to wait until said port with the highest priority having transmitted a pre-determined portion of said packet, then repeat said steps (b) to step (d), when said port with the highest priority is half-duplex.

4. The method as claimed in claim 3, wherein said pre-determined portion of said packet is 64 bytes.

5. The method as claimed in claim 3, wherein said pre-determined portion of said packet is 128 bytes.

6. The method as claimed in claim 1, wherein said selecting a port with the highest priority step means selecting a port of the highest priority group with the shortest output queue.

7. The method as claimed in claim 6, wherein said priority groups comprise a 1000 Mbps/full-duplex group, a 1000 Mbps/half-duplex group, a 100 Mbps/full-duplex group, a 100 Mbps/half-duplex group, a 10 Mbps/full-duplex group, and a 10 Mbps/half-duplex group.

8. The method as claimed in claim 1 further comprising a step of checking whether all said enqueuings to said port specified in said port mask are complete.

9. The method as claimed in claim 8 further comprising a step of releasing all related buffers of said multi-cast packets when finishing all said transmission specified in said port mask.

10. A media access control (MAC) chip, comprising:
a plurality of port control units for coupling a physical layer control chip;
a forwarding control unit for coupling said port control units;
a queue control unit for coupling said forwarding control unit and said port control units;
a shortest queue identification unit for coupling said queue control unit; and
a buffer control unit for coupling a buffer storage and said port control units;
wherein one of said port control units receives a multi-cast packet, said forwarding control unit generates a corresponding port mask for said multi-cast packet, said buffer control unit allocates a buffer from said buffer storage for storing said multi-cast packet, said queue control unit and said shortest queue identification unit coordinate to select a port, based on said port mask, of the highest priority group with the shortest output queue for enqueuing said multi-cast packet.

11. The MAC chip as claimed in claim 10, wherein said forwarding control unit generates said corresponding port mask by using a look-up table.

12. The MAC chip as claimed in claim 10, wherein if said port of the highest priority group having the shortest output queue is full-duplex, said multi-cast packet starts to enqueue into an output queue of a next port when said port of the highest priority group having the shortest output queue starts transmitting said packet.

13. The MAC chip as claimed in claim 10, wherein if said port of the highest priority group having the shortest output queue is half-duplex, said multi-cast packet starts to enqueue into an output queue of a next port when said port of the highest priority group having the shortest output queue have transmitted a pre-determined portion of said packet.

14. An Ethernet switch with a plurality of ports, comprising:
a physical layer control chip for providing a plurality of ports, and
a media access control chip for coupling said physical layer control chip;
wherein said physical layer control chip receives a multi-cast packet, said media access control chip generates a corresponding port mask for said packet, and select a port of the highest priority group with the shortest output queue based on said port mask, and enqueues said packet into said selected port.

15. A method for transmitting multi-cast packets, comprising the steps of:
(a) recording the capability of a plurality of remote ports based on the automatic coordination result of the Ethernet;
(b) determining the priority of a plurality of local ports in accordance with the transmission capability;
(c) receiving a multi-cast packet and generating a corresponding port mask to specify said plurality of local ports that said packet is to transmitted from;
(d) selecting a port with the highest priority and enqueuing said multi-cast packet into an output queue associated with said port and updating said port mask;
(e) checking if said port with the highest priority is full-duplex; and
(f) repeating said steps (d) to (f) based on the result of step (e) and repeating until finishing all the transmission specified by said port mask.

16. The method as claimed in claim 15, wherein said step (f) is to wait until said port with the highest priority starting transmitting said packet, then repeat said steps (d) to (f), when said port with the highest priority is full-duplex.

17. The method as claimed in claim 15, wherein said step (f) is to wait until said port with the highest priority having transmitted a pre-determined portion of said packet, then repeat said steps (d) to step (f), when said port with the highest priority is half-duplex.

18. The method as claimed in claim 15, wherein said priority groups comprise a 1000 Mbps/full-duplex group, a 1000 Mbps/half-duplex group, a 100 Mbps/full-duplex group, a 100 Mbps/half-duplex group, a 10 Mbps/full-duplex group, and a 10 Mbps/half-duplex group.

19. The method as claimed in claim 15 further comprising a step of checking whether all said enqueuings to said port specified in said port mask are complete.

20. The method as claimed in claim 19 further comprising a step of releasing all related buffers of said multi-cast packets when finishing all said transmission specified in said port mask.
